(19) United States
(12) Patent Application Publication
(10) Pub. No.: US 2011/0306401 A1
(43) Pub. Date: Dec. 15, 2011

(54) System And Method For Supporting Second Chance Gaming

(75) Inventor: Binh T. Nguyen, Reno, NV (US)

(73) Assignee: INTELLECTUAL GARDEN, LLC, Reno, NV (US)

(21) Appl. No.: 12/797,616

(22) Filed: Jun. 10, 2010

(51) Int. Cl. A63F 9/24; A63F 13/00

(52) U.S. Cl. 463/20; 463/30

(57) ABSTRACT

A gaming device may have at least one display configured to present a first game of chance, a game manager configured to initiate the first game of chance, a session manager configured to manage a user game play session involving the first game of chance, and a near-hit manager, wherein the near-hit manager can be configured to determine whether a near-hit triggering event occurs during the first game of chance, and then determine a near-hit award credit associated with the near-hit triggering event and record each of the near-hit award credits obtained during the user game play session.

### FIELD OF INVENTION

The present disclosure relates generally to a gaming device, gaming method and gaming system, and more particularly, to a gaming device, gaming method and gaming system for supporting second chance gaming.

### BACKGROUND OF THE INVENTION

The base game of most gaming machines now involves a plurality of reels, and the user can initiate the base game and the plurality of reels starts to spin. When the plurality of reels comes to a stop, the gaming machine can determine whether there is a predetermined combination of symbols, i.e. a winning payline and then issue award credits thereupon.

During the play of the game, there are times when most of the required winning symbols aligned on a payline, except for one symbol that lands just one or two positions away from the payline, giving the player a near-hit situation. These near-hits are naturally occurring due to the randomness of the spins, and they don't pay anything. Psychologically, the near-hits evoke a powerful emotion in a player, sometime a hopeful feeling at the moment of the near-hit, then turn to frustration quickly when a jackpot does not materialize (as it normally won't). Thus, the near-hits are memorable moments in the player experience, but a very negative experience. It leaves a bitter taste, and the player may not return to that game, or that casino, again. There is a type of slot game called a “nudge” game that features a symbol that falls just outside of a payline, but then creeps back into the payline to give a winning combination. However, players quickly realize that roundabout presentation is not a true second chance at the lost opportunity, as they would have won that spin anyway. Also, in the nudge game, naturally occurring near-hits do show up—just like any other game, but they don't get nudged into a winning payline. From the player's perspective, sometime a nudge occurs, sometime not. This creates confusions to the players as common sense dictates that for a nudge game, all near-hits situations should become winning games. For these reasons, a nudge game quickly loses its appeal. It is desirable to create a positive player experience each time a natural near-hit occurs, and in a memorable way that's entertaining as well as giving true value to a near-hit occurrence.

### BRIEF SUMMARY

Embodiments are described herein for a gaming device, method and system to detect and record near-hit award credits for a player. The near-hit award credits can be thereafter used to facilitate player's access to a second chance game.

In one embodiment, a gaming device comprises at least one display configured to present a first game of chance, a game manager configured to initiate the first game of chance, a session manager configured to manage a user game play session involving the first game of chance, and a near-hit manager. The near-hit manager can be configured to (i) determine whether a near-hit triggering event occurs during the first game of chance, (ii) determine a near-hit award credit associated with the near-hit triggering event, and (iii) record each of the near-hit award credits obtained during the user game play session.

In one another embodiment, a gaming method for facilitating access to a second chance game comprises providing a user with an opportunity to play a first game of chance on a first gaming device, detecting a near-hit triggering event in the first game of chance on the first gaming device, determining a near-hit award credit associated with the near-hit triggering event, accumulating the near-hit award credits for the second chance game, saving the accumulated near-hit award credits and permitting use of the saved accumulated near-hit award credits for the second chance game on the first gaming device or a second gaming device.

In yet another embodiment, a gaming system to facilitate access to a second chance game comprises at least one first gaming device to play a first game of chance, wherein the at least one first gaming device comprises at least one display configured to present the first game of chance. The gaming system further comprises at least one second gaming device configured to initiate a second chance game, wherein the at least one second gaming device for the second chance game includes a second chance game manager configured to permit the user to use the accumulated near-hit award credits to play the second chance game on the at least one second gaming device.

The first gaming device also comprises a game manager configured to initiate the first game of chance and a session manager configured to manage a user game play session involving the first game of chance. The first gaming device further comprises a near-hit manager configured to (i) determine whether a near-hit triggering event occurs during the first game of chance, (ii) determine a near-hit award credit associated with the near-hit triggering event and then (iii) accumulate each of the near-hit award credits obtained during the user game play session.

### BRIEF DESCRIPTION OF THE DRAWINGS

The accompanying drawings, which are incorporated into and constitute a part of this specification, illustrate one or more example embodiments and, together with the description of example embodiments, serve to explain the principles and implementations.

In the drawings:

FIG. 1 illustrates a front perspective view of a gaming device according to one embodiment.

FIG. 2 illustrates a block diagram of a gaming device according to one embodiment.

FIG. 3 illustrates a flow chart of method for facilitating access to a second chance game according to one embodiment.

FIG. 4 illustrates a flow chart of method for playing a second chance game according to one embodiment.

FIG. 5A illustrates a display showing an example of a winning payline.

FIG. 5B illustrates a display showing an example of a near-hit event.

FIG. 5C illustrates a display showing another example of a near-hit event.

FIG. 5D illustrates a display showing yet another example of a near-hit event.

FIG. 6A illustrates a display showing an example of a winning payline.

FIG. 6B illustrates a display showing an example of a near-hit event.

FIG. 6C illustrates a display showing another example of a near-hit event.

FIG. 6D illustrates a display of yet another example of a near-hit event.

### DESCRIPTION

Embodiments are described herein for a gaming device, system and method to detect and record near-hit award credits for a player. The near-hit award credits can be thereafter used to facilitate player access to a second chance game.

The following detailed description is illustrative only and is not intended to be in any way limiting. Other embodiments will readily suggest themselves to such skilled persons having the benefit of this disclosure. Reference will now be made in detail to implementations as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

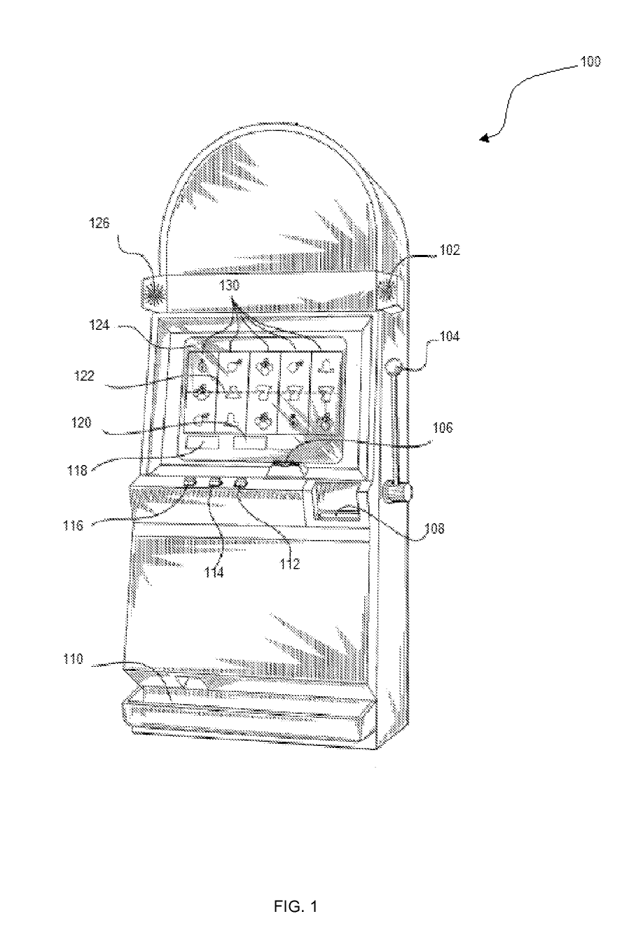

FIG. 1 illustrates a front perspective view of a gaming device 100 according to one embodiment. The gaming device 100 may have in one embodiment controls, displays and features of a conventional slot machine. The gaming device 100 may be constructed so that a player can operate it while standing or sitting. Furthermore, in another embodiment, the gaming device 100 can be programmed in a portable electronic device. The gaming device 100 can also be implemented as a program running on a computerized platform. Although we refer to the gaming device 100 as a slot machine, this is not intended to be limiting, and the gaming device 100 can be configured to be any type of primary game of chance such as blackjack, keno, bingo, poker and the like. Similarly, the second chance, or near-hit, game play invention is applicable not only to primary slot games, but secondary or bonus slot games, group slot games where many players are involved in the same game, or even traditional table games such as Black Jack and Poker. Moreover, the symbols or indicia used in the gaming device 100 can be any type of symbols or indicia, and the symbols and the indicia can be presented by, including but not limited to, mechanical, electrical, video or projection.

The gaming device 100 may comprise a currency acceptor, such as a coin slot 106 and a bill acceptor 108. The player can feed coins into the coin slot 106, or paper money or credit vouchers into the bill acceptor 108. The gaming device 100 can also be configured to accept other payment forms such as checks, credit cards or debit cards. When the player inserts money into the bill acceptor 108 or feeds coins into the coin slot 106, the gaming device 100 credits the player based on the amount deposited. The player can begin a game of chance by pulling arm 104 or can initiate the game of chance by using a play button 116. The play button 116 can be any kind of activator configured to start any game of chance or a user game play session in the gaming device 100 corresponding to the player's operation.

Although illustrated with one display 124, this is not intended to be limiting, the gaming device 100 may use more than one display. The screen of the display device 124 can be any viewing surface such as glass, a video monitor, a liquid crystal display, a multi-layer LCD display (MLD) where a transparent LCD is superimposed over a transmissive LCD, a transparent LCD display superimposed over physical electromechanical reels, or any other display mechanisms. The use of an overlaying or superimposed secondary transparent display on a primary display is especially informative as it can overlay a semi-transparent image of one or more “good” paylines over the “almost-good” payline(s). The display 124 may present a plurality of reels 130, and the plurality of reels 130 can be mechanical wheels, video or projection images, or any means that can work to display a plurality of visual symbols or indicia. The display 124 can be a touch screen configured to allow the player to interact with the gaming device 100, such as allowing the player to initiate a game of chance using a touch screen button, or pushing a mechanical button, instead of pulling a mechanical arm. Each of the plurality of reels 130 may spin upon initiation and presents a plurality of indicia or symbols such as bells, hearts, fruits, triangles, numbers, letters, bars or other symbols which may correspond to an associated gaming theme in the primary game of chance.

The gaming device 100 can also include a bet amount display 120 and a bet button 114. When the player uses the bet button 114 to increase the bet amount, the number of credit shown in the credit display 118 decreases appropriately and the number of credits shown in the bet amount display 120 increases by the same amount accordingly. During or after a user play game session, the player may choose to “cash out” by using a payout button 112, and thereby receives a number of credits representing the number of remaining credits or accumulated credits or both. When the player chooses to “cash out,” the remaining credits or accumulated credits or both can be printed out via an output device on a credit voucher representing such remaining or accumulated credits or both. In another embodiment, the credit voucher is a digital voucher, not printed out on paper, but digitally represented as a file, and transferred to a player's receiving device such as a smart phone. The digital voucher can be transferred to a receiving device via wired or wireless communication technologies such as Serial, Parallel, Ethernet, USB, Wireless USB, Wifi, WiMax, LTE, Zigbee, UWB, Near-Field Magnetic, and the like. In yet another embodiment, the player may receive a payout by receiving coins in a payout tray 110. The gaming device 100 may employ other payout mechanisms such as issuing credit slips redeemable by a cashier, digital voucher as described previously, or an electronic funds transfer to a player identification tracking card which can keep track of the player's credits as well as other relevant player information.

The gaming device 100 may support one or more paylines. By using more paylines, the player's odds of winning credits may be increased. Moreover, besides the ability to win credits for playing the gaming device 100, the gaming device 100 may also support near-hit award credits. Even if none of the paylines provided by the gaming device 100 yield credits for the player, if a game played (i.e., game spin) results in a near-hit, the player can receive a near-hit award credit. The near-hit award credits may be accumulated over one or more game play sessions. A game play session is a time duration in which many games are played in a substantially continuous manner by at least one player. The duration begins at time T1 when the player started to play one or more games, and ends at time T2 when the player cashes out, wherein time T2 is later than time T1. The credit display 118, or some other display, can display an indication of the accumulated near-hit award credits. In one embodiment, the near-hit award credits can be redeemed at the gaming device 100, for example, as a free spin, additional paylines, etc. In another embodiment, the near-hit award credits can be redeemed at a second chance game device. A second chance game device can be another gaming machine with its own random number generator and paytables that are fully compliant to the rules of a gaming jurisdiction in which it resides.

During or after a user play game session, the player may choose to “cash out” the near-hit award credits. For example, by using the payout button 112, the accumulated near-hit award credits can be printed out via the output device on a near-hit award voucher.

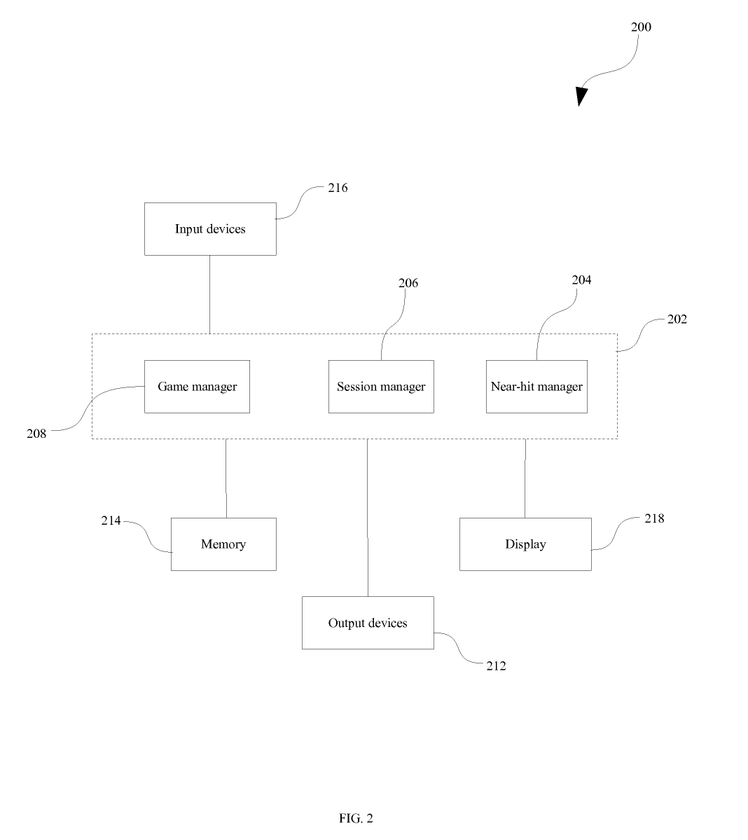

FIG. 2 illustrates a block diagram of a gaming device 200 according to one embodiment. The gaming device 200 can be, for example, the gaming device 100 illustrated in FIG. 1. The player can use different input devices 216 to deposit money or other forms of credits into the gaming device 200 and to input various different game operational inputs. The input devices 216 include, but not limited to, a coin slot, a bill acceptor, a mechanical arm, a play button, a bet button, joystick, voice, and cash out button. The gaming device 200 also comprises at least one processor 202 configured to perform the functions of a game manager 208, a session manager 206 and a near-hit manager 204. The gaming device 200 also comprises at least a memory 214 configured to store games and player records. The memory 214 can be Read-Only Memory (ROM), Random-Access Memory (RAM), non-volatile memory such as magnetic disk drive, optical disk drive, flash drive, Electrically Erasable Programmable Read-Only Memory (EEPROM), and the like. The gaming device 200 can further comprise output devices, including but not limited to, a speaker, a printer, digital outputs, lights, displays, and a payout device. The speaker can, for example, play different type of music to entertain a player when the player plays on the gaming device 200. The printer can, for example, be used to print out a credit voucher for a player representing the player's game credits or near-hit award credits or both. The payout device can be configured to distribute winning award credits. The gaming device 200 can also comprise at least one display 218 configured to display information to a player. The information being displayed on the display 218 may pertain to a user game play session as well as other interactive information.

The processor 202 can be configured to communicate with the input devices 216, output devices 212, and the at least one memory 214 and display 218. As mentioned above, the display 218 can include a touch screen so that it can be configured to perform some or all of the functions of input devices 216. The session manager 206 can be configured to manage a user game play session involving a first game of chance. When a player wants to play the first game of chance, the game manager 208 can be configured to initiate the first game of chance on the gaming device 200 in accordance with the player's operation. The first game of chance can then be presented on the display 218. The game manager 208 can detect a winning event (e.g., a winning payline) in the first game of chance and determine a winning award credit associated with such a winning event. When the player meets the winning event in the first game of chance, the game manager 208 can determine a winning award credit and save it to the memory 214. If there is no winning event detected in the first game of chance, a near-hit manager 204 comes into play. The near-hit manager 204 can be configured to (i) determine whether a near-hit triggering event occurs during the first game of chance, (ii) determine a near-hit award associated with the near-hit triggering event, and (iii) record each of the near-hit award credits obtained during the user game play session in the memory 214.

Although illustrated with processor 202 and memory 214, it is not intended to be limiting, these functions can be implemented by using one or more processors (e.g., microprocessors), by application-specific integrated circuits (ASICs) or other hardware, or by using mechanical devices. Furthermore, although the processor 202 and memory 214 can be embedded in each gaming device 200, some or all of their functions can also be provided from a central location such as a central server configured to communicate with a gaming device such as over a local area network, wide area network, internet connection, microwave link, Radio Frequency (RF) link, and the like.

In one embodiment, a player can play a first game of chance on the gaming device 100, 200. The player can insert the appropriate amount of money or tokens or other acceptable credits into the bill acceptor 108 or the coin slot 106 and then pull the arm 104 or simply use the play button 116. The game manager 208 can initiate a first game of chance based upon the player's input operations and the processor 202 will present the first game of chance on the display 124. The plurality of reels 130 can then begin to spin. Eventually, the plurality of reels 130 can come to a stop and present different combinations of a plurality of symbols. The game manager 208 can then determine whether the player gets a predetermined combination of symbols for a winning payout or bonus. In one embodiment, the first game of chance can include multiple paylines, and the paylines can be horizontal, vertical, diagonal or any combination thereof. When the game manager 208 determines there is a winning payout or bonus, it will store information concerning the winning payout or bonus into the memory 214. As long as the player has credits remaining, the player can choose to play again.

In addition to winning a payout or bonus in this manner by presenting a predetermined combination of symbols on the display 124, 218 in a first game of chance, the gaming device 100, 200 can also give players the opportunity to win opportunities (e.g., awards or credits) to play a second chance game. The gaming device 100, 200 includes the near-hit manager 204 which can automatically record a near-hit triggering event, wherein one or more symbols on one of the plurality of reels 130 is at least one position away from a payline of a predetermined combination of symbols for a winning payout. This qualifying condition can be any particular arrangement of symbols or indicia on a display 218 as discussed in greater details below. The near-hit manager 204 can be configured to detect such triggering event and determine the appropriate award associated with such a triggering event. The gaming device 100, 200 in one embodiment can be configured to allow the player to play a second chance game on the same gaming device 100, 200. The player can also choose to get the near-hit award credits printed out on a voucher and then play a second chance game on a different second gaming device.

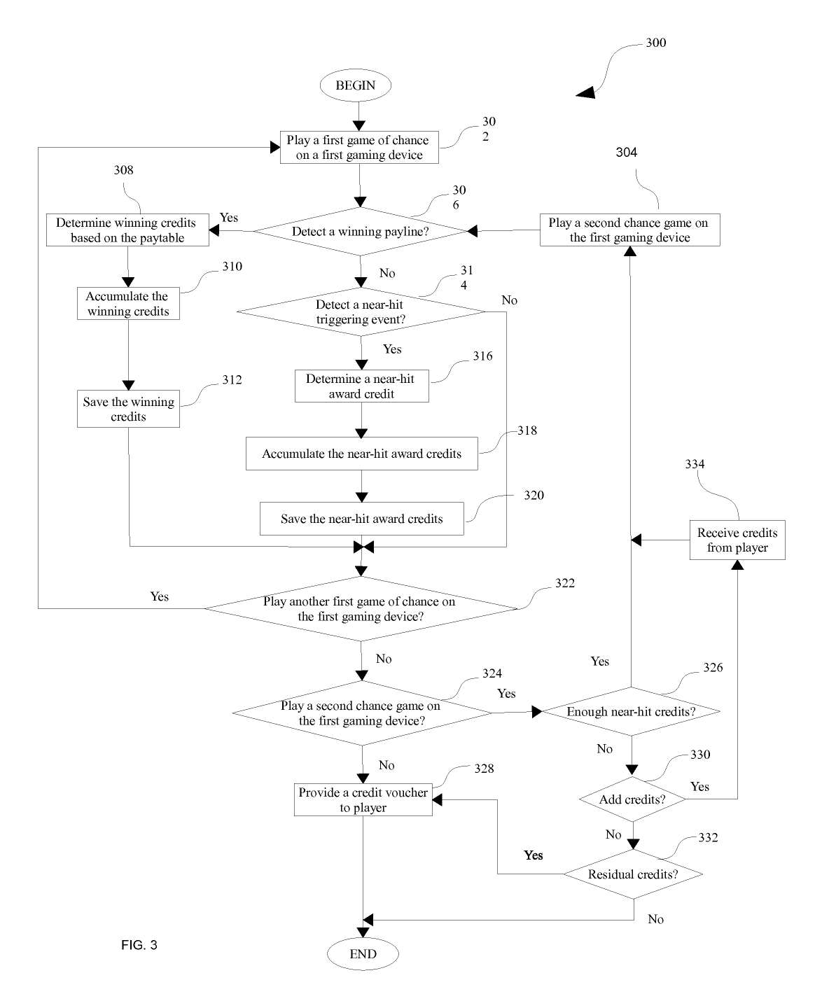

FIG. 3 illustrates a flowchart of method for facilitating access to a second chance game 300 according to one embodiment. The flow chart of method 300 is described with respect to the gaming device 100 illustrated in FIG. 1 and the gaming device 200 illustrated in FIG. 2. However, it should be understood that the processing depicted in the flow chart of method 300 can be performed on other gaming devices.

The method for facilitating access to a second chance game 300 begins with a player playing a first game of chance on a first gaming device 100, 200 at 302. In one embodiment, the session manager 206 can be configured to manage a user game play session involving the first game of chance. A user game play session is a contiguous play period starting at time T1 when a player starts the first game at a gaming device, until time T2 when a player leaves that gaming device. That is, the session manager detects all the games that a player plays during this period (T2−T1), subject to a predefined quiescent threshold. The game manager 208 can initiate the first game of chance in accordance with the player's operation. A plurality of reels 130 can be configured to spin when the first game of chance is initiated. After the plurality of reels 130 comes to a stop, the game manager 208 can detect whether there is a winning payline as defined by a predetermined combination of a plurality of symbols at 306. The predetermined combination of a plurality of symbols can be horizontal, vertical, diagonal or any form of combinations as defined by the first game of chance.

When the game manager 208 detects a winning payline at 306, the flowchart of method 300 then determines a winning credit based upon a paytable at 308. The winning credit can be any type of award, such as some amount of money, redeemable points, a song, a video clip, a lottery ticket, a car, a camera, a show ticket and the like. The first game of chance can include multiple paylines, and therefore there could be multiple winning paylines, and a different winning payline may be associated with a different winning credit. The game manager 208 can also accumulate the winning credits at 310 and save the winning credits into memory 214 at 312.

In case the game manager 208 does not detect any winning payline at 306, the near-hit manager 204 can then detect whether there is a near-hit triggering event at 314. The near-hit triggering event can pertain to situations in which one or more symbols is at least one position away from a predetermined combination of symbols representing a winning payline. The first game of chance can be configured to provide a near-hit triggering event when the wager passes a threshold amount. The casino can also configure the gaming machine to issue near-hit award credits to its privileged members (Gold Club member, for instance). When the near-hit manager 204 detects a near-hit triggering event at 314, the flowchart of method 300 then determines a near-hit award credit associated with the near-hit triggering event at 316.

Detection of a near-hit triggering event at step 314 and the determination of the near-hit award credit at step 316 can be done locally at the gaming device, or can be done remotely by a central server. In the local determination approach, the near-hit manager 204 of the gaming device uses a built-in algorithm to scan for the near-hit events, and looks up a second chance paytable in the gaming device, which may or may not be the same as the first game of chance's paytable, for the corresponding near-hit credit award. In the central determination approach, the game's symbols arrangement on the display can be captured and sent to a remote server for detecting and determination of the near-hit events and associated awards. Both the detection algorithms and the second chance paytable reside on the remote second chance game server. In the local detection and determination scenario, the gaming device can operate on a standalone mode, as well as less network traffic and better response if the game device has the computing power. In the scenario of centrally detecting and determination of awards using a remote server, the gaming device can operate with higher security, bridging compatibility with legacy gaming devices, and better control of the second-chance paytables. For example, the near-hit award paytable can be changed at the central server to allow bigger rewards during slow weekdays. In another embodiment, the second chance game paytable can be configured by the operator at a central location, and then downloaded to the local gaming devices.

The first game of chance can include multiple paylines, and therefore there could be multiple near-hit triggering events and each near-hit triggering event can be associated with a different near-hit award credit. The near-hit manager 204 can accumulate the near-hit award credits at 318 and then save the near-hit award credits into memory 214 at 320.

No matter whether there is a winning payline detected at 306 or a near-hit triggering event detected at 314, the flowchart of method 300 then can provide the player with a choice to play another first game of chance on the first gaming device at 322. When the player chooses to play another first game of chance on the first gaming device at 322, he or she can play the first game of chance on the first gaming device at 302 and then can repeat the process provided by the flow chart of method 300.

If the player does not want to play another first game of chance on the first gaming device at 322, he or she can still choose to play a second chance game on the first gaming device at 324. Optionally, the casino can set a minimum number of near-hit credits required to play the second chance game. In one embodiment, the player can only play the second chance game when the player has enough near-hit credits. In another embodiment, a player can purchase the credit shortage in order to play right away. The near-hit manager 204 can detect whether the player has enough near-hit credits at 326. If the player does not have enough near-hit credits, the processing of the flowchart of method 300 can ask the player to buy additional credits at 330, or to end. If the player does not want to add more credits, the session manager 206 can be configured to end the user game play session. If the player has enough near-hit credits at 326 or has purchased additional credits at 334, he or she can play a second chance game on the first gaming device at 304, the game manager can detect a winning payline at 306 and then proceed with subsequent processing at 306 as discussed above.

If the player chooses not to play a second chance game on the first gaming device at 324, or to cash out the residual credits at 332, the output devices 212 of the gaming device 200 can provide a credit voucher to the player representing the winning credits or accumulated near-hit award credits or both at 328. The session manager 206 can then end the user game play session. Though illustrated as a voucher, this is not intended to be limiting, the credits can be configured to provide in other ways, such as a player tracking card, a digital voucher that can be sent to a portable electronic device, emailed to a player's account, and the like. The player can, for example, redeem the voucher for winning credits and earned near-hit credits in a kiosk and the like. For the near-hit award credits, the player can use them to play a second chance game either on the same gaming device or on a second gaming device. An expiration date can be set for the voucher representing the near-hit award credits. Though the user game play session involving the first game of chance and the second chance game can be stored in a local gaming device, it can be saved on a central gaming server which can be configured to communicate with any local gaming devices over a local area network, wide area network, internet connection, Radio Frequency (RF) network, microwave link, and the like.

The first game of chance and the second chance game may be played on the same or different gaming machines and may be associated with a same or different game theme. The second chance game can, for example, pertain to a re-spin of all the reels in the first game of chance or selected reels of the first game of chance. The second chance game can also be a specific third-party sponsored game and subsidized cost-wise by the third-party and used as a platform to promote its products. The third party sponsors can also provide prizes for the near-hit credit players.

FIG. 4 illustrates a flowchart of method 400 for playing a second chance game according to one embodiment. The flowchart of method 400 is described with respect to the gaming device 100 illustrated in FIG. 1 and the gaming device 200 illustrated in FIG. 2. However, it should be understood that the process depicted in the flow chart of method 400 could be performed on other gaming devices.

The method for facilitating access to a second chance game 400 begins with a player playing the second game of chance on the second gaming device at 402. In one embodiment, the second gaming device can be the gaming device 100 or 200. The session manager 206 can be configured to manage a user game play session involving the second chance game. The player can receive a credit voucher issued in a first game of chance to play a second chance game on the second gaming device at 402. Optionally, the casino can set a threshold of near-hit credits required for the player to play a second chance game. When the player initiates the second chance game, and after a plurality of reels comes to a stop, the game manager 208 can detect whether there is a winning payline as defined by a predetermined combination of a plurality of symbols at 404. The predetermined combination of a plurality of symbols can be horizontal, vertical, diagonal or any form of combinations thereof. When the game manager 208 detects a winning payline at 404, it can then determine a winning credit based upon a paytable at 406. The winning credit can be any type of award, such as some amount of money, a song, a video clip, a lottery ticket, a car, a camera, a show ticket and the like. The second chance game can include multiple paylines, and therefore there could be multiple winning paylines, and a different winning payline may be associated with a different winning credit. The game manager 208 can accumulate the winning credits at 408 and can then save the winning credits into memory 214 at 410.

If the game manager 208 does not detect any winning payline at 404, the near-hit manager 204 can then detect whether there is any near-hit triggering event at 412. The near-hit triggering event can pertain to situations in which one or more symbols is at least one position away from a predetermined combination of symbols representing a winning payline. The second chance game can be configured to provide a near-hit triggering event when the wager passes a threshold amount. The casino can also configure the gaming machine to issue near-hit credits to its privileged players, such as Gold Club members. When the near-hit manager 204 detects a near-hit triggering event at 412, the flowchart of method 400 then determines a near-hit award credit associated with the near-hit triggering event at 414. The second chance game can include multiple paylines, and therefore there can be multiple near-hit triggering events and each near-hit triggering event can be associated with a different near-hit award credit. The near-hit manager 204 can accumulate the near-hit award credits at 416 and then save the near-hit award credits into memory 214 at 418. The near-hit award credits can be configured to allow the player to play a second chance game. The second chance game can be the same as or different from the first game of chance; the second chance game can also be a re-spin of a selected reel or a re-spin of all reels.

No matter whether there is a winning payline detected at 404 or a near-hit triggering event detected at 412, the flow chart of method 400 can provide the player with a choice to play another second chance game on the second gaming device at 420, wherein the player can simply initiate another second chance game. When the player chooses to play another second game of chance on the second gaming device at 420, he or she then can repeat the process provided by the flow chart of method 400 as mentioned above. A casino can also set a threshold of required near-hit credits for the player to play a second chance game. The casino can determine to only allow the player to play some predetermined second chance games based on the amount of near-hit credits. As mentioned above, the second chance game can be the same as the first game of chance. And the casino can also use a specific third-party sponsored game as the second chance game. The third-party game may be a newly released game, so the game provider can use this near-hit game method as a platform to promote its new game and as the same time it can provide the players prizes for the near-hit credit plays.

If the player chooses not to play a second chance game on the second gaming device at 420, in one embodiment, the player can choose to “cash out.” An output device of the second gaming device can provide a credit voucher to the player representing the winning credits or near-hit award credits or both at 422. The session manager will end the user game play session thereafter. Though illustrated as a voucher, this is not intended to be limiting, the game can be configured to provide all reasonable medium representing the said credits, such as an electronic credit transfer to a player tracking account, or allowing the player to email a digital version of the credit voucher to himself or download to a portable electronic device. The player can also redeem the winning credits in a Kiosk and the like. For the near-hit award credits voucher, the player can use it to play a second chance game later on a gaming device as set by the casino. In one embodiment, the casino can set an expiration date for using such near-hit award credits. Though the user game play session involving the first game of chance and the second chance game can be embedded in a local gaming device, it can be saved on a central gaming server which can be configured to communicate with a local gaming device such as over a local area network, wide area network, RF wireless network, internet connection, microwave link, and the like.

The first game of chance and the second chance game can refer to the same or different games. The second chance game can, for example, pertain to a full re-spin of the first game of chance (pulling a new random number from the random number generator) or can pertain to just a re-spin of a selected reel. The second chance game can also be a third party sponsored game and used by the third party as a platform to promote its products. The third party sponsored game can also provide prizes for the user of the near-hit credits.

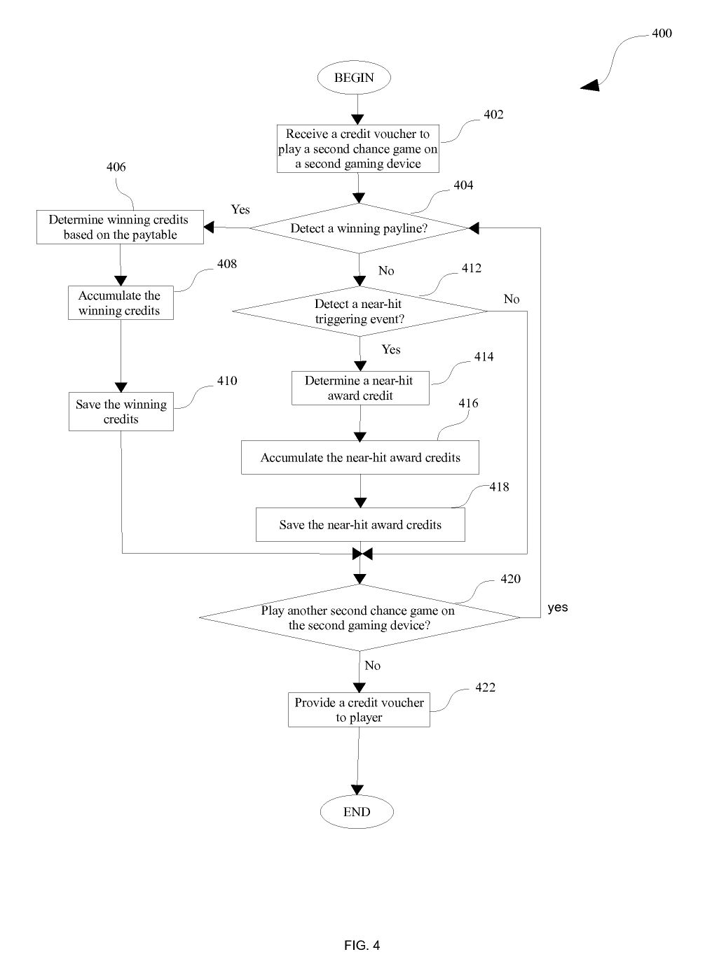

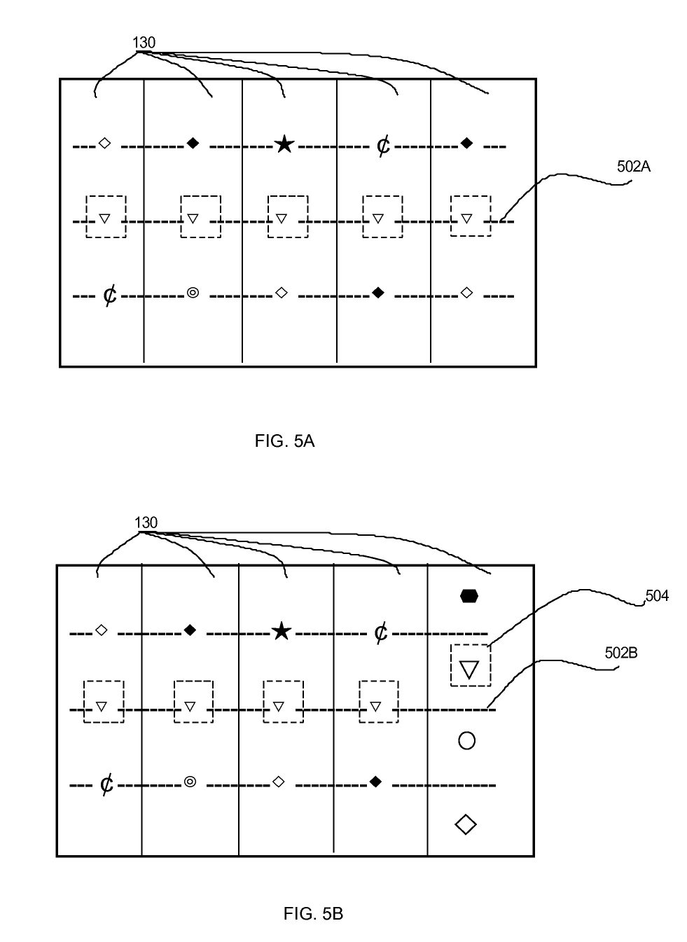

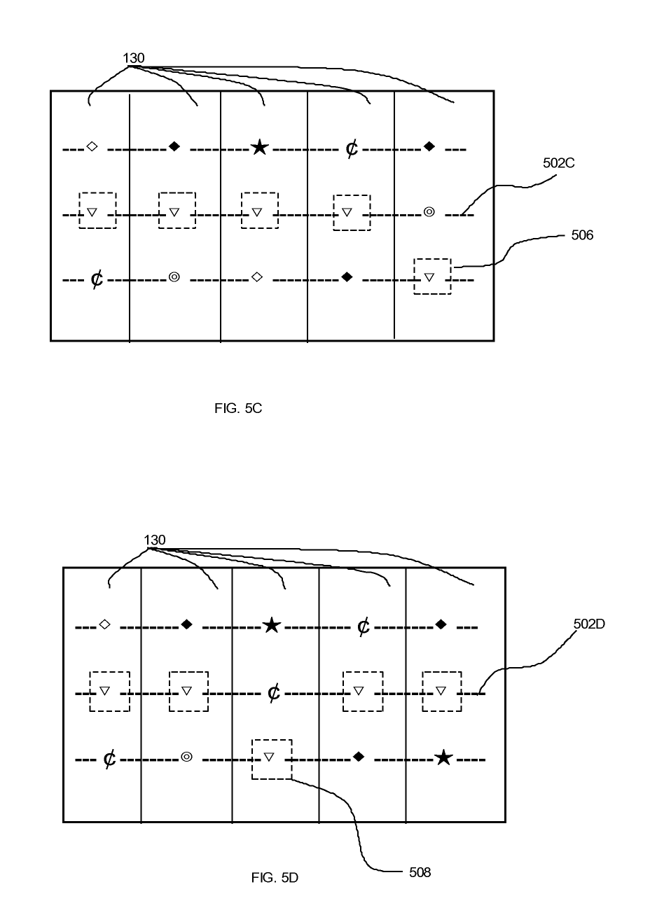

FIG. 5A illustrates a display showing an example of a winning payline. In one embodiment, there is one activated payline 502A. The display may present a plurality of reels 130, and the plurality of reels 130 can be mechanical wheels, video or projection images, or any means that can work to display a plurality of visual symbols or indicia. As shown in FIG. 5A, the plurality of reels 130 can be illustrated as having symbols. In this embodiment, the “∇” symbols are the predetermined winning symbols and the appearance of five “∇” symbols on any activated payline such as payline 502A is a predetermined combination of symbols for a winning payline, and the player can then get a payout. Any symbol combination comprising the same symbol or designated symbols may be used as the combination for a winning payline.

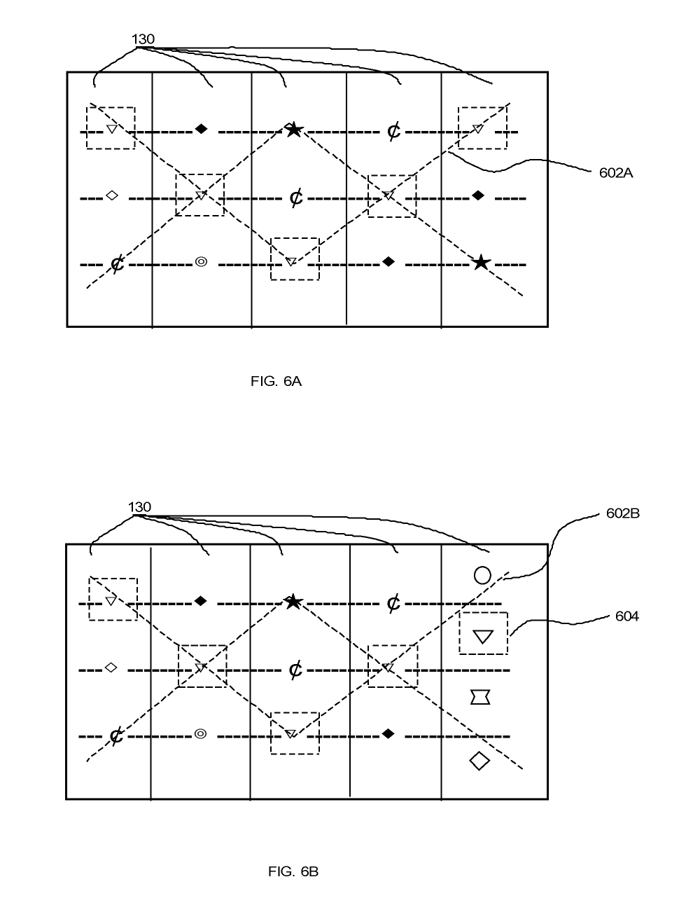

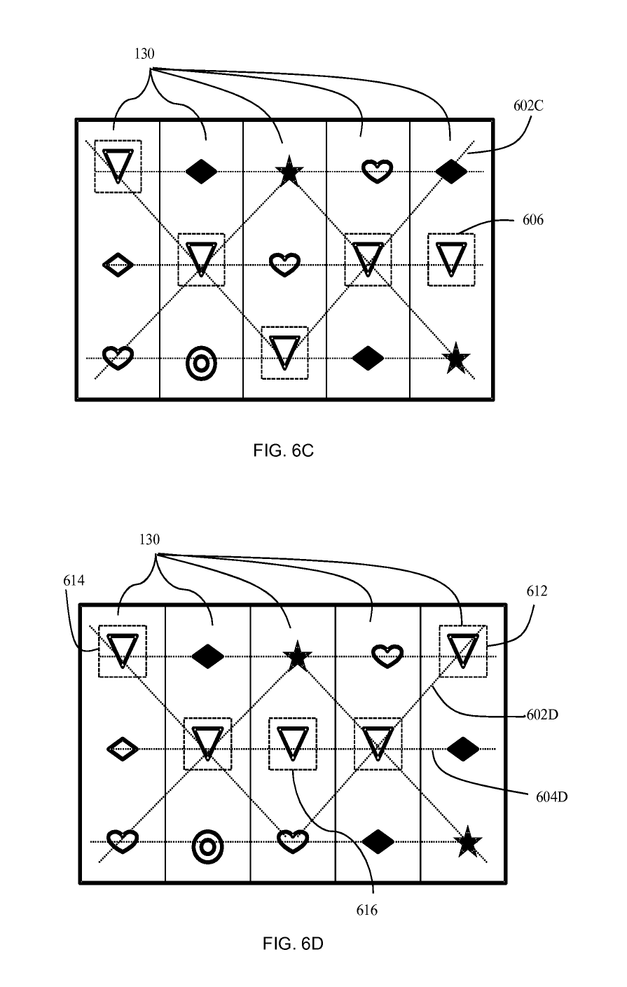

FIG. 5B illustrates a display showing an example of a near-hit event. In one embodiment, there is one activated payline 502B. There are already four symbols “∇” aligned along the payline 502B. A near-hit triggering symbol “∇” 504 is one position away from the payline 502B of the combination of four symbols “∇”. If the near-hit triggering symbol “∇” 504 is right on the payline 502B, this will make the payline 502B, which already has four symbol “∇,” a winning payline as shown in FIG. 5A. In this embodiment, the near-hit triggering symbol “∇” 504 is not on any payline, and is between the payline 502B and an inactive payline adjacent to the payline 502B. Whenever the plurality of reels 130 comes to a stop, in one embodiment, the near-hit manager 204 can detect whether there is a near-hit triggering event and can then determine a near-hit award credit associated with the near-hit triggering event. Though the near-hit triggering symbol “∇” 504 can be on the last reel as shown in FIG. 5B, the near-hit triggering symbol “∇” 504 can be designed to appear on any one of the plurality of reels 130, and it can be one or more positions away from the payline which can be a winning payline if not for the near-hit triggering symbol “∇” 504's deviation. The near-hit triggering symbol also does not refer to any specific symbol, it can be any symbol on any one of the plurality of reels 130. The game designer can also design the near-hit award associated with a near-hit triggering event based on where the near-hit triggering symbol stops. Although the embodiment shows there is only one near-hit triggering symbol on one payline, the game can be configured to include two or more near-hit triggering symbols for a near-hit triggering event on one or more paylines. For instance, the center horizontal payline on FIG. 6C illustrates a two-symbol near-hit payline.

FIG. 5C illustrates a display showing another example of a near-hit event. In one embodiment, there is one activated payline 502C. A near-hit triggering symbol “∇” 506 is one position away from the payline 502C of the combination of four symbols “∇” and stops on the payline adjacent to the payline 502C. Whenever the plurality of reels 130 comes to a stop, in one embodiment, the near-hit manager can detect this near-hit triggering event and determine a near-hit award credit associated with the near-hit triggering event. Though the near-hit triggering symbol “∇” 506 can appear on the last reel as shown in FIG. 5C, the near-hit triggering symbol “∇” 506 can appear on any one of the plurality of reels 130, as long as it is one or more positions away from the payline which can be a winning payline if not for the near-hit triggering symbol “∇” 506's deviation. The near-hit triggering symbol also does not refer to any specific symbol; it can be any symbol on any one of the pluralities of reels 130.

FIG. 5D illustrates a display showing yet another example of a near-hit event, wherein there is also only one activated payline 502D. In one embodiment, the near-hit triggering symbol “∇” 508 can be on a different reel and stops one position away from the payline 502D of the combination of four symbols “∇”. The game can be configured to determine the near-hit award associated with a near-hit triggering event based on where the near-hit triggering symbol stops. Although the embodiment shows there is only one near-hit triggering symbol on one payline, the game can be configured to include two or more near-hit triggering symbols for a near-hit triggering event on one or more paylines.

FIG. 6A illustrates a display showing one example of a winning payline. The display may present a plurality of reels 130, and the plurality of reels 130 can be mechanical wheels, video or projection images, or any means that can work to display a plurality of visual symbols or indicia. In one embodiment, the first game of chance can include multiple activated paylines. As shown in FIG. 6A, the game has five different activated paylines, either horizontal or diagonal. In this embodiment, the symbols “∇” are the predetermined symbols and the appearance of five symbols “∇” on any activated payline such as payline 602A is a predetermined winning event. Any symbol combination having the same symbol or other designated symbols may be used as the combination for a winning event.

FIG. 6B illustrates a display showing an example of a near-hit event. In one embodiment, there are multiple activated paylines. A near-hit triggering symbol “∇” 604 is one position away from a payline 602B. If the near-hit triggering symbol “∇” 604 is right on the payline 602B, this will make the payline 602B a winning payline which has already four symbols “∇” aligned on it as shown in FIG. 6A. In this embodiment, the near-hit triggering symbol “∇” 604 is not on any payline. The game can be configured to determine a near-hit award associated with a near-hit triggering event depending on where the near-hit triggering symbol stops. In one embodiment, whenever the plurality of reels 130 comes to a stop, the near-hit manager can detect any near-hit triggering event and determine a near-hit award credit associated with the near-hit triggering event. Though the near-hit triggering symbol “∇” 604 appears on the last reel as shown in FIG. 6B, the near-hit triggering symbol “∇” 604 can appear on any one of the plurality of reels 130, as long as it is one position away from the payline of the combination of four predetermined symbols which can be a winning payline if not for the near-hit triggering symbol “∇” 604's deviation. The near-hit triggering symbol “∇” 604 also does not refer to any specific symbol; it can be any symbol on any one of the pluralities of reels 130. The game can be configured to determine the near-hit award associated with a near-hit triggering event based on where the near-hit triggering symbol stops. Although the embodiment shows there is only one near-hit triggering symbol, the game can be configured to include two or more near-hit triggering symbols for one or more near-hit triggering events and near-hit awards associated with multiple paylines.

FIG. 6C illustrates a display showing another example of a near-hit event. In this embodiment, there are multiple activated paylines. A near-hit triggering symbol “∇” 606 is one position away from a payline 602C of a combination of four symbols “∇”, and stops on a payline adjacent to the payline 602C. Whenever the plurality of reels 130 comes to a stop, in one embodiment, the near-hit manager can detect this kind of near-hit triggering event and determine a near-hit award credit associated with the near-hit triggering event. Though the near-hit triggering symbol “∇” 606 can appear on the last reel as shown in FIG. 6C, the near-hit triggering symbol “∇” 606 actually can appear on any one of the pluralities of reels 130, as long as it is one (or depending on the game design, more than one) position away from the payline which can be a winning payline if not for the near-hit triggering symbol “∇” 606's deviation.

Although the embodiment shows there is only one near-hit triggering symbol, the game can also be configured to include two or more near-hit triggering symbols for more than one near-hit triggering events associated with multiple paylines. For instance, if payline 604C is also in played in addition to payline 602C, and more than one near-hit symbols is allowed, payline 604C is now an additional near-hit event. Each of symbols 608 and 610 is within one position from the payline 604C, creating another near-hit event.

FIG. 6D illustrates a display of yet another example of a near-hit event, wherein the near-hit triggering symbol “∇” 616 can be on a different reel and stops one position away from the payline 602D of a combination of four symbols “∇”. The near-hit triggering symbol “∇” 616 also does not refer to any specific symbol; it can be any symbol on any one of the pluralities of reels 130. The game can be configured to determine the near-hit award associated with a near-hit triggering event based on where the near-hit triggering symbol stops. Although the embodiment shows there is only one near-hit triggering symbol, the game can also be configured to include two or more near-hit triggering symbols for more than one near-hit triggering events associated with multiple paylines. For instance, if payline 604D is also in played in addition to payline 602D, and more than one near-hit symbols is allowed, payline 604D is now an additional near-hit event. Each of symbols 612 and 614 is within one position from the payline 604D, creating another near-hit event.

This intention further provides a gaming system to facilitate access to a second chance game. In one embodiment, the system comprises at least one first gaming device to play a first game of chance, and at least one second gaming device configured to initiate a second chance game, the said at least one second gaming device for the second chance game includes a second chance game manager configured to permit the user to use the accumulated near-hit award credits to play the second chance game on the at least one second gaming device at a later time. The near-hit award credits can be accumulated while playing a user game play session on the first gaming device. As mentioned above, the at least one first gaming device and the at least one second gaming device can be the same gaming device.

While the present invention is described in connection with what is presently considered to be the most practical and preferred embodiments, it should be appreciated that the invention is not limited to the disclosed embodiments, and is intended to cover various modifications and equivalent arrangements included within the spirit and scope of the claims. Modifications and variations in the present invention may be made without departing from the novel aspects of the invention as defined in the claims, and this application is limited only by the scope of the claims.

What is claimed is:

1. A gaming device, comprising:
at least one display configured to present a first game of chance;
a game manager configured to initiate the first game of chance;
a session manager configured to manage a user game play session involving the first game of chance; and
a near-hit manager configured to: (i) determine whether a near-hit triggering event occurs during the first game of chance; (ii) determine a near-hit award credit associated with the near-hit triggering event; (iii) record each of the near-hit award credits obtained during the user game play session.

2. The gaming device of claim 1, wherein the near-hit manager is further configured to record an accumulated near-hit award credit over the user game play session.

3. The gaming device of claim 1, further comprising:
a memory configured to save the accumulated near-hit award credits.

4. The gaming device of claim 3, further comprising an output device configured to provide a second chance game voucher representing the saved accumulated near-hit award credits.

5. The gaming device of claim 2, wherein the accumulated near-hit award credits are used on the gaming device or on another gaming device.

6. The gaming device of claim 1, wherein the near-hit triggering event occurs when at least one symbol in a set of symbols for the first game of chance is at least one position away from a payout payline.

7. The gaming device of claim 1, further comprising a plurality of rotatable reels displayed on the at least one display, each of the rotatable reels comprises a plurality of symbols such that when the rotatable reels are stopped, a set of symbols is displayed,
wherein the near-hit triggering event occurs when at least one symbol in a set of symbols for the first game of chance is at least one position away from a payout payline.

8. A gaming method for facilitating access to a second chance game, comprising:
providing a user with an opportunity to play a first game of chance on a first gaming device;
detecting a near-hit triggering event in the first game of chance on the first gaming device;
determining a near-hit award credit associated with the near-hit triggering event;
accumulating the near-hit award credits for the second chance game;
saving the accumulated near-hit award credits; and
permitting use of the saved accumulated near-hit award credits for the second chance game on the first gaming device or a second gaming device.

9. The gaming method of claim 8, wherein the first gaming device is a slot machine.

10. The gaming method of claim 8, wherein the detecting comprises:
presenting a set of symbols for the first game of chance on a display of the first gaming device; and
determining whether one or more symbols in the set of symbols is one position away from a payout payline.

11. The gaming method of claim 8, wherein the accumulated near-hit award credits are accumulated while playing a user game play session on the first gaming device.

12. The gaming method of claim 8, further comprising:
providing a second chance game voucher representing the saved accumulated near-hit award credits.

13. The gaming method of claim 12, wherein the providing includes printing the second chance game voucher.

14. The gaming method of claim 12, where the voucher is a digital voucher.

15. The gaming method of claim 8, further comprising:
providing the user with an opportunity to play the second chance game using the saved accumulated near-hit award credits on the second gaming device.

16. A gaming system to facilitate access to a second chance game, comprising:
at least one first gaming device to play a first game of chance, wherein the at least one first gaming device comprises:
at least one display configured to present the first game of chance;
a game manager configured to initiate the first game of chance;
a session manager configured to manage a user game play session involving the first game of chance; and
a near-hit manager configured to: (i) determine whether a near-hit triggering event occurs during the first game of chance; (ii) determine a near-hit award credit associated with the near-hit triggering event; (iii) accumulate each of the near-hit award credits obtained during the user game play session; and
at least one second gaming device configured to initiate a second chance game, the at least one second gaming device for the second chance game includes a second chance game manager configured to permit the user to use the accumulated near-hit award credits to play the second chance game on the at least one second gaming device.

17. The gaming system of claim 16, wherein the at least one first gaming device to play a first game of chance is configured to present a set of symbols for the first game of chance on the at least one display of the first gaming device, whereby the near-hit manager determines whether one or more symbols in the set of symbols is one position away from a payout payline.

18. The gaming system of claim 16, wherein each of the near-hit award credits is accumulated while playing a user game play session on the first gaming device.

19. The gaming system of claim 16, wherein the at least one first gaming device to play the first game of chance further comprises a memory to save the accumulated near-hit award credits.

20. The gaming system of claim 19, wherein the at least one first gaming device to play the first game of chance further comprises at least one output device configured to provide a second chance game voucher representing the saved accumulated near-hit award credits.

20. The gaming system of claim 20, wherein the output device is a printer configured to print the second chance game voucher.

21. The gaming system of claim 20, where the voucher is a digital voucher.

22. The gaming system of claim 16, wherein the at least one first gaming device and the at least one second gaming device is the same gaming device.
